(19) United States
(12) Patent Application Publication
(10) Pub. No.: US 2022/0253705 A1
(43) Pub. Date: Aug. 11, 2022

(54) METHOD, DEVICE AND COMPUTER READABLE STORAGE MEDIUM FOR DATA PROCESSING

(71) Applicant: NEC CORPORATION, Tokyo (JP)

(72) Inventors: Xiaoyi CHEN, Beijing (CN); Ni ZHANG, Beijing (CN)

(73) Assignee: NEC CORPORATION, Tokyo (JP)

(21) Appl. No.: 17/666,638

(22) Filed: Feb. 8, 2022

(30) Foreign Application Priority Data
Feb. 9, 2021 (CN) 2021101820934

(51) Int. Cl. G06N 3/08

(52) U.S. Cl. CPC G06N 3/08

(57) ABSTRACT

Embodiments of the present disclosure relate to methods, devices and computer readable storage media for data processing. The method comprises obtaining input data. The method further comprises generating, by using a neural network, a predicted label indicating a class of the input data. The neural network comprises a weighted layer that determines at least a weight applied to at least one candidate class to generate a predicted result. The input data is possibly belonging to the at least one candidate class. In this way, the predicted label may be generated more accurately.

### FIELD

Embodiments of the present disclosure relate to the field of data processing, and more specifically, to methods, devices and computer readable storage media for data processing.

### BACKGROUND

With the development of information technologies, neural networks are widely used in various machine learning tasks such as computer vision, speech recognition and information retrieval. The accuracy of the neural network depends on a training data set with accurate labels. However, in practice, some training data in the training data set might have an incorrect noisy label. For example, there might be training data with noisy labels in the training data set automatically collected from the network or in a training data set in which an error might occur when the labels are manually annotated. However, conventionally, it is impossible to well process the training data with the noisy label such that the accuracy of the neural network trained with such a training data set is undesirable.

### SUMMARY

Embodiments of the present disclosure provide methods, devices and computer readable storage media for data processing.

According to a first aspect of the present disclosure, there is provided a method for data processing. The method comprises: obtaining input data; and generating, by using a neural network, a predicted label indicating a class of the input data, the neural network comprising a weighted layer, the weighted layer determining at least a weight applied to at least one candidate class to generate a predicted result, the input data possibly belonging to the at least one candidate class.

According to a second aspect of the present disclosure, there is provided a method for training a neural network. The method comprises: obtaining training data having a label indicating a class of the training data; generating, by using a neural network, a predicted label of the training data, the neural network comprising a weighted layer, the weighted layer generating a predicted result at least based on a weight applied to at least candidate class, the training data possibly belonging to the at least one candidate class; and training the neural network to minimize a difference between the label and the predicted label.

According to a third aspect of the present disclosure, there is provided a method for training a neural network. The method comprises: obtaining training data having a label indicating a class of the training data; generating a predicted label of the training data by using a neural network; training the neural network to minimize a loss of the neural network, the loss being determined at least based on a weight applied to at least candidate class, the training data possibly belonging to the at least one candidate class.

According to a fourth aspect of the present disclosure, there is provided an electronic device. The electronic device comprises at least one processing circuit. The at least one processing circuit is configured to: obtain input data; and generate, by using a neural network, a predicted label indicating a class of the input data, the neural network comprising a weighted layer, the weighted layer determining at least a weight applied to at least one candidate class to generate a predicted result, the input data possibly belonging to the at least one candidate class.

According to a fifth aspect of the present disclosure, there is provided an electronic device. The electronic device comprises at least one processing circuit. The at least one processing circuit is configured to: obtain training data having a label indicating a class of the training data; generate, by using a neural network, a predicted label of the training data, the neural network comprising a weighted layer, the weighted layer generating a predicted result at least based on a weight applied to at least candidate class, the training data possibly belonging to the at least one candidate class; and train the neural network to minimize a difference between the label and the predicted label.

According to a sixth aspect of the present disclosure, there is provided an electronic device. The electronic device comprises at least one processing circuit. The at least one processing circuit is configured to: obtain training data having a label indicating a class of the training data; generate a predicted label of the training data by using a neural network; train the neural network to minimize a loss of the neural network, the loss being determined at least based on a weight applied to at least candidate class, the training data possibly belonging to the at least one candidate class.

According to a seventh aspect of the present disclosure, there is provided a computer-readable storage medium. The computer-readable storage medium has computer-executable instructions stored thereon, the computer-executable instructions, when executed by a device, cause the device to perform the method according to the first aspect of the present disclosure.

According to an eighth aspect of the present disclosure, there is provided a computer-readable storage medium. The computer-readable storage medium has computer-executable instructions stored thereon, the computer-executable instructions, when executed by a device, cause the device to perform the method according to the second aspect of the present disclosure.

According to a ninth aspect of the present disclosure, there is provided a computer-readable storage medium. The computer-readable storage medium has computer-executable instructions stored thereon, the computer-executable instructions, when executed by a device, cause the device to perform the method according to the third aspect of the present disclosure.

The Summary is to introduce a selection of concepts in a simplified form which will be further described below in the Detailed Description. The Summary is not intended to identify key features or essential features of the present disclosure, nor is it intended to be used to limit the scope of the present disclosure. Other features of the present disclosure will be made apparent by the following depictions.

### BRIEF DESCRIPTION OF THE DRAWINGS

The objects, advantages and other features of the present invention will become more apparent from the following disclosure and claims. For the purpose of illustration only, non-limiting depictions of the preferred embodiments are presented with reference to figures, wherein:

FIG. 1 illustrates a schematic diagram of an example of a data processing environment in which some embodiments of the present disclosure can be implemented;

FIG. 2 illustrates a schematic diagram of an example of a neural network according to some embodiments of the present disclosure;

FIG. 3 illustrates a flowchart of an example method for data processing according to embodiments of the present disclosure;

FIG. 4 illustrates a flowchart of an example method for training a neural network according to embodiments of the present disclosure;

FIG. 5 illustrates a flowchart of an example method for training a neural network according to embodiments of the present disclosure;

FIG. 6 illustrates a schematic diagram of an example of the accuracy of a neural network along with epochs and an example of the accuracy of a conventional neural network with epochs according to embodiments of the present disclosure; and

FIG. 7 illustrates a schematic block diagram of an example computing device that can be used to implement embodiments of the present disclosure.

Throughout the drawings, the same or similar reference numerals refer to the same or similar elements.

### DETAILED DESCRIPTION OF EMBODIMENTS

Hereinafter, embodiments of the present disclosure will be described in more detail with reference to the accompanying drawings. Although some embodiments of the present disclosure are shown in the drawings, it is to be understood that the present disclosure can be implemented in various forms and should not be construed as being limited to the embodiments set forth herein. On the contrary, these embodiments are provided to enable a more thorough and complete understanding of the present disclosure. It is to be appreciated that the drawings and embodiments of the present disclosure are only used for exemplary purposes, and are not intended to limit the protection scope of the present disclosure.

As used herein, the term “includes” and its variants are to be read as open terms that mean “includes, but is not limited to.” The term “based on” is to be read as “based at least in part on.” The terms “one embodiment” or “the embodiment” is to be read as “at least one example embodiment.” The term “first,” “second,” and the like may refer to different or the same objects. Other definitions, either explicit or implicit, may be included below.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In the embodiments of the present disclosure, the term “model” can process input and provide corresponding output. Taking a neural network model as an example, it usually includes an input layer, an output layer, and one or more hidden layers between the input layer and the output layer. A model used in deep learning applications (also referred to as “a deep learning model”) usually include many hidden layers, thereby extending the depth of the network. The layers of the neural network model are connected in sequence such that the output of the previous layer is used as the input of the next layer, where the input layer receives the input of the neural network model, and the output of the output layer serves as a final output of the neural network model. Each layer of the neural network model includes one or more nodes (also referred to as processing nodes or neurons), and each node processes input from the previous layer. In the text herein, the terms “neural network”, “model”, “network” and “neural network model” may be used interchangeably.

As stated above, some training data in a training data set might have incorrect noisy labels. Conventionally, various noisy label learning approaches have been used to overcome the adverse effects of noisy labels. For example, a noisy label learning approach can re-weight the training data based on the loss, for example, applying higher weights for training data with correct clean labels, and lower weights for training data with noisy labels. In this case, it is necessary to distinguish noisy labels from clean labels for different weighting. Alternatively, semi-supervised learning can be performed by selecting training data with clean labels.

Another approach is probabilistic and calculating a confusion matrix or other similar probability matrix based on the training result with standard loss. Other approaches also use the robust loss, which means that the optimal solution of the neural network remains the same with or without a noisy label, making the performance of the neural network poorer. In addition, iteratively updating the training data set with clean labels during the training process has also been proven empirically effective. In addition, co-teaching such as two-model joint learning has also been proven effective. The various approaches listed above can also be combined, for example, co-teaching may be combined with iterative updating to overcome adverse impact caused by the noisy labels.

However, these conventional manners still cannot handle the training data with noisy labels well, such that the accuracy of the neural network trained through such training data sets is undesirable.

Embodiments of the present disclosure propose a solution for data processing to solve one or more of the above-mentioned problems and/or other potential problems. In this solution, input data may be obtained, and the neural network may be utilized to generate a predicted label indicating the class of the input data. The neural network includes a weighted layer. The weighted layer may generate a predicted result based on a weight applied to at least one candidate class to which the input data might belong, a random value obeying a predetermined distribution, and/or at least one mode parameter associated with a predetermined mode.

In this way, by using the weighted layer, the effects of noisy labels on the neural network can be eliminated. As a result, the accuracy of the predicted label produced by the neural network and the recognition rate of noisy labels can be improved simply and efficiently. Hereinafter, example embodiments of the present disclosure will be described in detail with reference to the accompanying drawings.

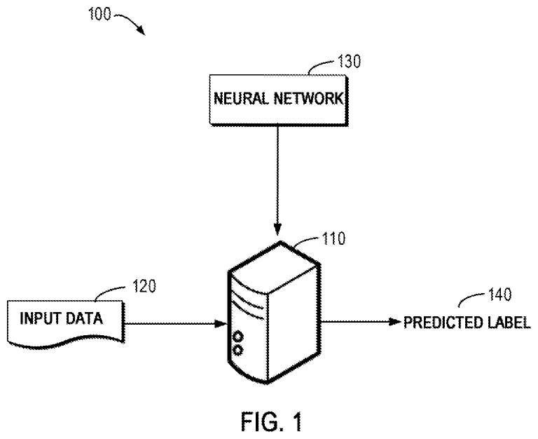

FIG. 1 illustrates a schematic diagram of an example of a data processing environment 100 in which some embodiments of the present disclosure can be implemented. The environment 100 comprises a computing device 110. The computing device 110 may be any device with computing capabilities, such as a personal computer, a tablet computer, a wearable device, a cloud server, a mainframe, a distributed computing system, and so on.

The computing device 110 obtains input data 120. For example, the input data 120 may be an image, video, audio, text and/or multimedia file, etc. The computing device 110 may apply the input data 120 to the neural network 130 to use the neural network 130 to generate a predicted label 140 indicating the class of the input data.

For example, assuming that the input data 120 is an image, the computing device 110 may use the neural network 130 to generate a predicted label 140 indicating the class of the image, such as a cat or a dog. In addition to the classification task, the neural network 130 may also be used for other tasks, such as a pixel-level segmentation task, an object detection tasks, and so on.

The neural network 130 may be deployed on the computing device 110 or outside the computing device 110. The neural network 130 may be a Deep Neural Network (DNN), a Convolutional Neural Network (CNN), a Long Short Term Memory (LSTM) network, a Gated Recurrent Unit (GRU) network, and/or a Recurrent Neural Network (RNN), and so on.

The neural network 130 comprises a weighted layer. In some embodiments, the last layer of the original neural network may be a fully connected layer, such as a DNN, LSTM, GRU, RNN network or the like. In this case, the fully connected layer may be used to replace the weighted layer to generate the neural network 130. Alternatively, the weighted layer may be added to the original neural network to generate the neural network 130. For example, the weighted layer is added to the last layer of the CNN network to generate the neural network 130.

In some embodiments, the weighted layer 210 may determine a weight applied to at least one candidate class to generate a predicted result, the input data possibly belonging to the at least one candidate class. In some embodiments, the weighted layer 210 may determine a random value that obeys a predetermined distribution to generate a predicted result. For example, the predetermined distribution may be a normal distribution, or any suitable distribution determined based on historical data. Alternatively, the weighted layer 210 may determine at least one mode parameter associated with a predetermined mode, to generate a predicted result. For example, the predetermined mode may be a Gaussian distribution, a normal distribution, a uniform distribution, an exponential distribution, a Poisson distribution, Bernoulli distribution, and/or Laplace distribution, etc. Alternatively, the predetermined mode may be any suitable mode determined based on historical data. In this case, unlike the original neural network outputting a deterministic predicted result, the predicted result of the neural network 130 comprising the weighted layer is a sampling result that obeys the predetermined mode. As a result, the adverse impact of noisy labels can be reduced.

It is to be appreciated that although the weighted layer 210 is described above as determining one of the following to generate the predicted result: the weight applied to at least one candidate class to which the input data possibly belong, a random value obeying a predetermined distribution, and at least one mode parameter associated with a predetermined mode, the weighted layer 210 may further determine any combination of these items to generate the predicted result. That is, the weighted layer 210 may determine any one, any two, or all three of these items to generate the predicted result.

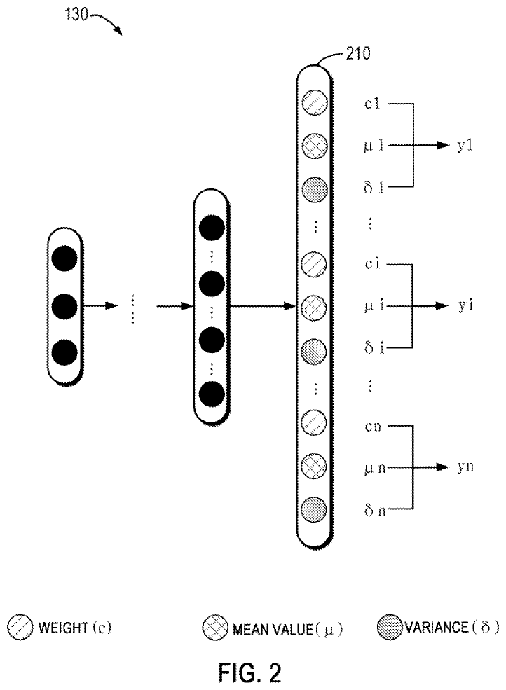

FIG. 2 illustrates a schematic diagram of an example of a neural network 130 according to some embodiments of the present disclosure. As shown in FIG. 2, the neural network 130 comprises a weighted layer 210. The output of at least one layer before the weighted layer 210 in the neural network 130 may be used as the input of the weighted layer 210. The input indicates the possibility that the input data belongs to at least one candidate class. For example, assuming that there are n candidate classes (where n is an integer greater than 0), the input may indicate the probabilities that the input data belong to each of the n candidate classes.

The weighted layer 210 has at least one parameter, and at least one mode parameter associated with a predetermined mode and a weight applied to at least one candidate class may be determined based on the at least one parameter of the weighted layer 210 and the input of the weighted layer 210. For example, assuming that the predetermined mode is a Gaussian distribution, at least one mode parameter may be a mean value and a variance of the Gaussian distribution.

As shown in FIG. 2, the weights applied to the n candidate classes are respectively c₁ to cₙ (hereinafter collectively referred to as “c”), the mean values are respectively μ₁ to μₙ (hereinafter collectively referred to as “μ”), and the variances are respectively δ₁ to δₙ (hereinafter collectively referred to as “0”).

In some embodiments, the weight c, the mean value μ, and the variance δ may be determined by the following Equations (1)-(3):

c=h(W_{c}f(x)) (1),

μ=W_{μ}f(x) (2),

δ=exp[W_{δ}f(x)] (3),

where c=(c₁, . . . , cₙ) represents the weights applied to n candidate classes, where C∈(0, 1) and Σᵢ₌₁ⁿcᵢ=1; μ=(μ₁, . . . , μₙ). represent the mean values associated with n candidate classes; δ=(δ₁, . . . , δₙ) represents the variances associated with n candidate classes; f(x) represents the output of at least one layer before the weighted layer 210 in the neural network 130; W_{c}, W_{μ}, and W_{δ} respectively represent the parameters associated with the weight c, mean value μ and variance δ. Initially, these parameters may be determined randomly or empirically. During the training process of the neural network 130, these parameters will converge to appropriate values; h represents a softmax function; exp represents an exponential function, such that the variance δ is always positive.

Thus, the predicted result may be generated based on at least one mode parameter associated with the predetermined mode and the weight applied to the at least one candidate class. The predicted result may indicate the possibility that the input data belongs to at least one candidate class. In some embodiments, in addition to at least one mode parameter and the weight, the predicted result may also be generated based on a random value that obeys a predetermined distribution. As a result, randomness may be introduced into the predicted result, such that the adverse effects caused by noisy labels may be reduced.

FIG. 2 illustrates predicted results y1 to yn (hereinafter collectively referred to as “y”). The predicted results y1 to yn may indicate the possibility that the input data belongs to a respective candidate class among the n candidate classes.

The predicted result y may be determined by the following Equation (4):

y=c*(μ+ε*δ) (4),

where y=(y₁, . . . , yₙ). represents the possibility that the input data belongs to n candidate classes; c=(c₁, . . . , cₙ) represents the weight applied to n candidate classes; μ=(μ₁, . . . , μₙ). Represents the mean value associated with n candidate classes; δ=(δ₁, . . . , δₙ). represents the variance associated with n candidate classes; c represents a random value in the interval (0, 1), which obeys a predetermined distribution; * represents multiplication of elements.

Thus, the neural network 130 may generate a predicted label based on at least one mode parameter, a weight, and a random value that obeys a predetermined distribution.

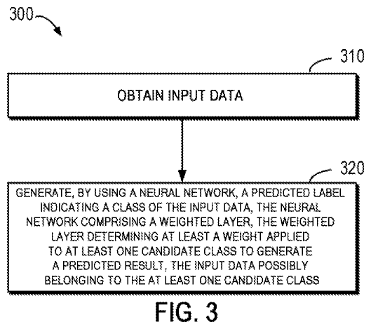

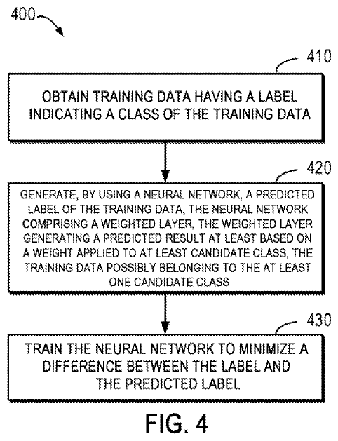

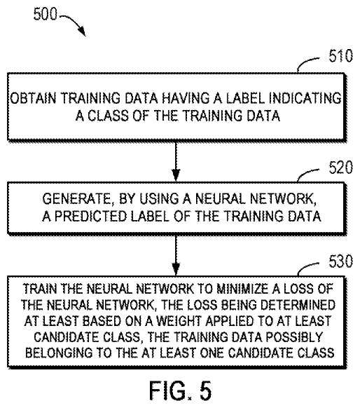

The structure of the neural network 130 is clearly described above with reference to FIG. 2, the use of the neural network 130 will be described with reference to FIG. 3, and the training of the neural network 130 will be described with reference to FIGS. 4-5.

FIG. 3 illustrates a flowchart of an example method 300 for data processing according to embodiments of the present disclosure. For example, the method 300 may be executed by the computing device 110 as shown in FIG. 1. It is to be appreciated that the method 300 may further include additional blocks not shown and/or some blocks shown may be omitted. The scope of the present disclosure is not limited in this respect.

At block 310, the computing device 110 obtains input data 120. As stated above, in some embodiments, the input data 120 may be an image, a video, an audio, a text and/or a multimedia file, etc.

At block 320, the computing device 110 generates a predicted label 140 indicating the class of the input data 120 by using the neural network 130. As stated above, in some embodiments, the neural network 130 may be a Deep Neural Network (DNN), a Convolutional Neural Network (CNN), a Long Short Term Memory (LSTM) Network, a Gated Recurrent Unit (GRU) network, and/or a Recurrent Neural Network (RNN), etc.

The neural network 130 comprises a weighted layer 210. The weighted layer 210 determines at least a weight applied to at least one candidate class to generate a predicted result. The input data 120 possibly belongs to the at least one candidate class. Further, in some embodiments, the weighted layer 210 further determines at least one mode parameter associated with the predetermined mode to generate a predicted result to cause the predicted result to obey the predetermined mode. As described above, in some embodiments, the predetermined mode may be a Gaussian distribution, a normal distribution, a uniform distribution, an exponential distribution, a Poisson distribution, a Bernoulli distribution, and/or Laplace distribution etc. For example, in the case where the predetermined mode is the Gaussian distribution, the at least one mode parameter may comprise a mean value and a variance of the Gaussian distribution. In some embodiments, the weighted layer 210 may determine the at least one mode parameter associated with the predetermined mode and the weight applied to the at least one candidate class in the manner described with reference to FIG. 2, which is not described any more here.

Thus, the computing device 110 may generate a predicted result based on the at least one mode parameter associated with the predetermined mode and the weight applied to the at least one candidate class. The predicted result may indicate the possibility that the input data belongs to at least one candidate class. In some embodiments, in addition to the at least one mode parameter and the weight, the computing device 110 may further generate the predicted result based on a random value that obeys a predetermined distribution. As a result, randomness may be introduced into the predicted result, such that the adverse effects caused by noisy labels may be reduced.

Specifically, in some embodiments, in order to generate the predicted label, the computing device 110 may obtain the output of the at least one layer before the weighted layer 210 in the neural network as the input of the weighted layer 210. The input indicates the possibility that the training data belongs to the at least one candidate class. The computing device 110 may determine the at least one mode parameter associated with the predetermined mode and the weight applied to the at least one candidate class based on at least one parameter of the weighted layer 210 and the input of the weighted layer. Thus, the computing device 110 may generate the predicted label based on the at least one mode parameter, the weight, and the random value that obeys the predetermined distribution.

In this way, the effects of noisy labels on the neural network can be eliminated. As a result, the accuracy of the predicted label produced by the neural network and the recognition rate of noisy labels can be improved simply and efficiently.

Using the neural network 130 by the computing device 130 to perform data processing is described above with reference to FIG. 3. The neural network 130 is a trained neural network. In some embodiments, the computing device 110 may train the neural network 130 and utilize the trained neural network 130 for data processing. Alternatively, the computing device 110 may also obtain a trained neural network from other devices, and utilize the trained neural network 130 for data processing. Hereinafter, the training of the neural network 130 will be described with reference to FIGS. 4-5 by taking the training of the neural network by the computing device 110 as an example.

FIG. 4 shows a flowchart of an example method 400 for training a neural network according to embodiments of the present disclosure. For example, the method 400 may be executed by the computing device 110 as shown in FIG. 1. It is to be appreciated that the method 400 may also include additional blocks not shown and/or some blocks shown may be omitted. The scope of the present disclosure is not limited in this respect.

At block 410, the computing device 110 obtains training data. The training data has a label indicating the class of the training data. For example, the training data may be an image, a video, an audio, a text and/or a multimedia file etc. For example, the label may indicate whether the image is a cat or a dog.

At block 420, the computing device 110 generates a predicted label of the training data by using the neural network 130. As stated above, in some embodiments, the neural network 130 may be a Deep Neural Network (DNN), a Convolutional Neural Network (CNN), a Long Short Term Memory (LSTM) Network, a Gated Recurrent Unit (GRU) network, and/or a Recurrent Neural Network (RNN), etc.

The neural network 130 comprises a weighted layer 210. As stated above, the weighted layer 210 determines at least a weight applied to at least one candidate class to generate a predicted result. The training data possibly belongs to the at least one candidate class. Further, in some embodiments, the weighted layer 210 further determines at least one mode parameter associated with the predetermined mode to generate a predicted result to cause the predicted result to obey the predetermined mode. As described above, in some embodiments, the predetermined mode may be a Gaussian distribution, a normal distribution, a uniform distribution, an exponential distribution, a Poisson distribution, a Bernoulli distribution, and/or Laplace distribution etc. For example, in the case where the predetermined mode is the Gaussian distribution, the at least one mode parameter may include a mean value and a variance of the Gaussian distribution. In some embodiments, the weighted layer 210 may determine the at least one mode parameter associated with the predetermined mode and the weight applied to the at least one candidate class in the manner described with reference to FIG. 2, which is not described any more here.

Thus, the computing device 110 may generate a predicted result based on the at least one mode parameter associated with the predetermined mode and the weight applied to the at least one candidate class. The predicted result may indicate the possibility that the training data belongs to at least one candidate class. In some embodiments, in addition to the at least one mode parameter and the weight, the computing device 110 may further generate the predicted result based on the random value that obeys the predetermined distribution. As a result, randomness may be introduced into the predicted result, such that the adverse effects caused by noisy labels may be reduced, without the need to distinguish the noisy labels from the clean labels.

Specifically, in some embodiments, in order to generate the predicted label, the computing device 110 may obtain the output of the at least one layer before the weighted layer 210 in the neural network as the input of the weighted layer 210. The input indicates the possibility that the training data belongs to the at least one candidate class. The computing device 110 may determine the at least one mode parameter associated with the predetermined mode and the weight applied to the at least one candidate class based on at least one parameter of the weighted layer 210 and the input of the weighted layer. Thus, the computing device 110 may generate the predicted label based on the at least one mode parameter, the weight, and the random value that obeys the predetermined distribution.

At block 430, the computing device 110 trains the neural network to minimize a difference between a label and the predicted label. In some embodiments, in order to train the neural network 130, the computing device 110 may determine the loss of the neural network 130 based on the label, the predicted label, and the weight applied to at least one candidate class. The adverse effects of the noisy labels on the loss may be counteracted by considering the weight applied to the at least one candidate class upon determining the loss. Thus, the trained neural network minimizes the difference between the real label and the predicted label.

For example, assuming that the original neural network is a DNN and its loss is a cross-entropy loss, the loss of the neural network 130 may be determined by the following Equation (5):

minL={Σᵢ₌₁ⁿl(yᵢ,yᵢ^{gt})−βΣᵢ₌₁ⁿ log(cᵢ)} (5),

where min represents a minimization function; L represents the loss of the neural network 130; l represents the cross-entropy loss of the DNN; yᵢ represents the possibility that the input data belongs to the i^{th} candidate class; yᵢ^{gt} represents a ground truth that the input data belongs to the i^{th} candidate class; β represents an annealing hyperparameter, which is always positive; cᵢ represents the weight applied to the i^{th} candidate class.

As known from the analysis of Equation (5), when all cᵢ are equal, −Σᵢ₌₁ⁿ log(cᵢ) is the smallest. In other words, when the weights applied to n candidate classes are equal, −Σᵢ₌₁ⁿ log(cᵢ) is the smallest. When yᵢ is approximate to yᵢ^{gt}, Σᵢ₌₁ⁿl(yᵢ,yᵢ^{gt}) is the smallest. Since yᵢ is determined based on cᵢ (for example, using Equation (4)), this means that when cᵢ has a peak value, Σᵢ₌₁ⁿl(yᵢ,yᵢ^{gt}) is the smallest. It may be seen that the two parts of the loss −Σᵢ₌₁ⁿ log(cᵢ) and Σᵢ₌₁ⁿl(yᵢ,yᵢ^{gt}) resist each other, thereby counteracting the adverse effects of noisy labels on the loss.

Therefore, the computing device 110 may update the network parameters of the neural network 130 based on the loss to minimize the loss of the updated neural network 130. Further, in some embodiments, the computing device 110 may update the at least one parameter of the weighted random layer based on the loss to minimize the loss of the updated neural network 130.

The training of the neural network 130 comprising the weighted layer 210 has been described above. In this training process, the loss of the neural network is minimized. As stated above, the loss takes into account the weights applied to the at least one candidate class, such that the neural network does not overfit on noisy labels. This loss-determining manner may also be applied to other neural networks, such as a neural network that does not comprise the weighted layer 210. Hereinafter, the process of training a neural network with such a loss will be described with reference to FIG. 5.

FIG. 5 illustrates a flowchart of an example method 500 for training a neural network according to embodiments of the present disclosure. For example, the method 500 may be executed by the computing device 110 as shown in FIG. 1. It is to be appreciated that the method 500 may also comprise additional blocks not shown and/or some blocks shown may be omitted. The scope of the present disclosure is not limited in this respect.

At block 510, the computing device 110 obtains training data. The training data has a label indicating the class of the training data. For example, the training data may be an image, a video, an audio, a text and/or a multimedia file, etc. For example, the label may indicate whether the image is a cat or a dog.

At block 520, the computing device 110 generates a predicted label for the training data using a neural network. As stated above, in some embodiments, the neural network may be a Deep Neural Network (DNN), a Convolutional Neural Network (CNN), a Long Short Term Memory (LSTM) Network, a Gated Recurrent Unit (GRU) network, and/or a Recurrent Neural Network (RNN), etc.

In some embodiments, the neural network 130 comprises a weighted layer 210. As stated above, the weighted layer 210 determines at least a weight applied to at least one candidate class to generate a predicted result. The training data possibly belongs to the at least one candidate class. Further, in some embodiments, the weighted layer 210 further determines at least one mode parameter associated with the predetermined mode to generate a predicted result to cause the predicted result to obey the predetermined mode. As described above, in some embodiments, the predetermined mode may be a Gaussian distribution, a normal distribution, a uniform distribution, an exponential distribution, a Poisson distribution, a Bernoulli distribution, and/or Laplace distribution etc. For example, in the case where the predetermined mode is the Gaussian distribution, the at least one mode parameter may comprise a mean value and a variance of the Gaussian distribution. In some embodiments, the weighted layer 210 may determine the at least one mode parameter associated with the predetermined mode and the weight applied to the at least one candidate class in the manner described with reference to FIG. 2, which is not described any more here.

Thus, a predicted result is generated based on the at least one mode parameter associated with the predetermined mode and the weight applied to the at least one candidate class. The predicted result may indicate the possibility that the training data belongs to at least one candidate class. In some embodiments, the predicted result may also be generated based on a random value that obeys a predetermined distribution in addition to the at least one mode parameter and the weight. As a result, randomness may be introduced into the predicted result, such that the adverse effects caused by noisy labels may be reduced.

Specifically, in some embodiments, in order to generate the predicted label, the computing device 110 may obtain the output of the at least one layer before the weighted layer 210 in the neural network as the input of the weighted layer 210. The input indicates the possibility that the training data belongs to at least one candidate class. The computing device 110 may determine the at least one mode parameter associated with the predetermined mode and the weight applied to the at least one candidate class based on at least one parameter of the weighted layer 210 and the input of the weighted layer. Thus, the computing device 110 may generate the predicted label based on the at least one mode parameter, the weight, and the random value that obeys the predetermined distribution.

At block 530, the computing device 110 trains the neural network to minimize the loss of the neural network. The loss is determined based on the weight applied to at least one candidate class, the training data possibly belonging to the at least one candidate class. In some embodiments, in order to train the neural network, the computing device 110 may determine the loss of the neural network based on the label, the predicted label, and the weight applied to the at least one candidate class. In some embodiments, the computing device 110 may determine the loss in the manner described with reference to FIG. 3, which will not be described any more here.

Thus, the computing device 110 may update the network parameters of the neural network based on the loss to minimize the loss of the updated neural network. Further, in some embodiments, the computing device 110 may update the at least one parameter of the weighted random layer based on the loss, to minimize the loss of the updated neural network.

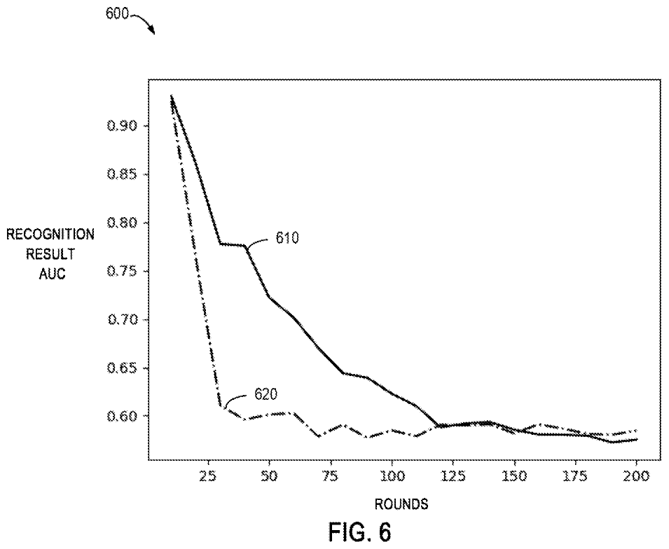

FIG. 6 shows a schematic diagram 600 of an example of a recognition result AUC (Area Under Curve) of a neural network according to embodiments of the present disclosure and a recognition result AUC of a conventional neural network. The recognition result AUC may represent a rate at which the neural network correctly recognizes the labels, and more specifically, a rate at which the neural network correctly recognizes the noisy labels. As shown in FIG. 6, a solid line 610 represents the recognition result AUC of the neural network including the weighted layer, and a dotted line 620 represents the recognition result AUC of the conventional neural network. It may be seen that the recognition result AUC of the neural network comprising the weighted layer is significantly higher than that of the conventional neural network. In addition, the neural network including the weighted layer can have a high recognition result AUC at a faster rate in fewer rounds.

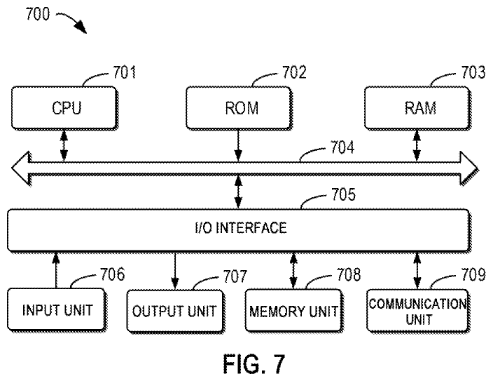

FIG. 7 illustrates a schematic block diagram of an example computing device 700 that can be used to implement embodiments of the present disclosure. For example, the computing device 700 shown in FIG. 7 comprises a central processing unit (CPU) 701 that may perform various appropriate actions and processing based on computer program instructions stored in a read-only memory (ROM) 702 or computer program instructions loaded from a memory unit 708 to a random access memory (RAM) 703. In the RAM 703, there further store various programs and data needed for operations of the device 700. The CPU 701, ROM 702 and RAM 703 are connected to each other via a bus 704. An input/output (I/O) interface 705 is also connected to the bus 704.

Various components in the device 700 are connected to the I/O interface 705, including: an input unit 706 such as a keyboard, a mouse and the like; an output unit 707 including various kinds of displays and a loudspeaker, etc.; a memory unit 708 including a magnetic disk, an optical disk, and etc.; a communication unit 709 including a network card, a modem, and a wireless communication transceiver, etc. The communication unit 709 allows the device 700 to exchange information/data with other devices through a computer network such as the Internet and/or various kinds of telecommunications networks.

Various processes and processing described above, e.g., methods 300 to 500 may be executed by the processing unit 701. For example, in some embodiments, methods 300 to 500 may be implemented as a computer software program that is tangibly included in a machine readable medium, e.g., the storage unit 707. In some embodiments, part or all of the computer program may be loaded and/or mounted onto the device 700 via ROM 702 and/or communication unit 709. When the computer program is loaded to the RAM 703 and executed by the CPU 701, one or more steps of the methods 300 to 500 as described above may be executed.

In some embodiments, an electronic device includes at least one processing circuit. The at least one processing circuit is configured to: obtain input data; and generate, by using a neural network, a predicted label indicating a class of the input data, the neural network comprising a weighted layer, the weighted layer determining at least a weight applied to at least one candidate class to generate a predicted result, the input data possibly belonging to the at least one candidate class.

In some embodiments, the weighted layer further determines at least one mode parameter associated with a predetermined mode to generate the predicted result to cause the predicted result to obey the predetermined mode.

In some embodiments, the predetermined mode comprises one of the following: a Gaussian distribution, a normal distribution, a uniform distribution, an exponential distribution, a Poisson distribution, a Bernoulli distribution and a Laplace distribution.

In some embodiments, the at least one processing circuit is configured to: obtain an output of at least one layer before the weighted layer in the neural network as an input of the weighted layer, the input indicating a possibility that the input data belongs to at least one candidate class; determine, based on at least one parameter of the weighted layer and the input of the weighted layer, at least one mode parameter associated with the predetermined mode and the weight applied to the at least one candidate class; and generate the predicted label based on the at least one mode parameter, the weight, and a random value obeying a predetermined distribution.

In some embodiments, the predetermined mode is a Gaussian distribution, and the at least one mode parameter comprises a mean value and a variance of the Gaussian distribution.

In some embodiments, the neural network comprises one of the following: a Deep Neural Network (DNN), a Convolutional Neural Network (CNN), a Long Short Term Memory (LSTM) Network, a Gated Recurrent Unit (GRU) network, and a Recurrent Neural Network (RNN).

In some embodiments, the input data comprises at least one of the following: an image, a video, an audio, a text and a multimedia file.

In some embodiments, the electronic device comprises at least one processing circuit. The at least one processing circuit is configured to: obtain training data having a label indicating a class of the training data; generate, using a neural network, a predicted label of the training data, the neural network comprising a weighted layer, the weighted layer generating a predicted result at least based on a weight applied to at least candidate class, the training data possibly belonging to the at least one candidate class; and train the neural network to minimize a difference between the label and the predicted label.

In some embodiments, the weighted layer further determines at least one mode parameter associated with a predetermined mode to generate the predicted result to cause the predicted result to obey the predetermined mode.

In some embodiments, the predetermined mode comprises one of the following: a Gaussian distribution, a normal distribution, a uniform distribution, an exponential distribution, a Poisson distribution, a Bernoulli distribution and a Laplace distribution.

In some embodiments, the at least one processing circuit is configured to: obtain an output of at least one layer before the weighted layer in the neural network as an input of the weighted layer, the input indicating a possibility that the training data belongs to the at least one candidate class; determine, based on at least one parameter of the weighted layer and the input of the weighted layer, at least one mode parameter associated with the predetermined mode and the weight applied to the at least one candidate class; and generate a predicted label based on the at least one mode parameter, the weight, and a random value obeying a predetermined distribution.

In some embodiments, the predetermined mode is a Gaussian distribution, and the at least one mode parameter comprises a mean value and a variance of the Gaussian distribution.

In some embodiments, the at least one processing circuit is configured to: determine a loss of the neural network based on the label, the predicted label, and the weight applied to the at least one candidate class; and update network parameters of the neural network based on the loss to minimize the loss of the updated neural network.

In some embodiments, the at least one processing circuit is configured to: update at least one parameter of the weighted layer based on the loss to minimize the loss of the updated neural network.

In some embodiments, the neural network comprises one of the following: a Deep Neural Network (DNN), a Convolutional Neural Network (CNN), a Long Short Term Memory (LSTM) Network, a Gated Recurrent Unit (GRU) network, and a Recurrent Neural Network (RNN).

In some embodiments, the training data comprises at least one of the following: an image, a video, an audio, a text and a multimedia file.

In some embodiments, the electronic device comprises at least one processing circuit. The at least one processing circuit is configured to: obtain training data having a label indicating a class of the training data; generate, by using a neural network, a predicted label of the training data; and train the neural network to minimize the loss of the neural network, the loss being determined at least based on a weight applied to at least candidate class, the training data possibly belonging to the at least one candidate class.

In some embodiments, the neural network comprises a weighted layer that generates a predicted result based at least on the weight applied to at least one candidate class.

In some embodiments, the weighted layer further determines at least one mode parameter associated with a predetermined mode to generate a predicted result to cause the predicted result to obey the predetermined mode.

In some embodiments, the predetermined mode comprises one of the following: a Gaussian distribution, a normal distribution, a uniform distribution, an exponential distribution, a Poisson distribution, a Bernoulli distribution and a Laplace distribution.

In some embodiments, the at least one processing circuit is configured to: obtain an output of at least one layer before the weighted layer in the neural network as an input of the weighted layer, the input indicating a possibility that the training data belongs to the at least one candidate class; determine, based on at least one parameter of the weighted layer and the input of the weighted layer, at least one mode parameter associated with the predetermined mode and a weight applied to the at least one candidate class; and generate a predicted label based on the at least one mode parameter, the weight, and a random value obeying a predetermined distribution.

In some embodiments, the predetermined mode is a Gaussian distribution, and the at least one mode parameter comprises a mean value and a variance of the Gaussian distribution.

In some embodiments, the at least one processing circuit is configured to: determine the loss based on the label, the predicted label, and the weight applied to the at least one candidate class; and update network parameters of the neural network based on the loss to minimize the loss of the updated neural network.

In some embodiments, the at least one processing circuit is configured to: update at least one parameter of the weighted layer based on the loss to minimize the loss of the updated neural network.

In some embodiments, the neural network comprises one of the following: a Deep Neural Network (DNN), a Convolutional Neural Network (CNN), a Long Short Term Memory (LSTM) Network, a Gated Recurrent Unit (GRU) network, and a Recurrent Neural Network (RNN).

In some embodiments, the training data comprises at least one of the following: an image, a video, an audio, a text and a multimedia file.

The present disclosure may be implemented as systems, methods and/or computer program products. When the present disclosure is implemented as a system, in addition to being implemented on a single device, the components described herein may also be implemented in the form of a cloud computing architecture. In a cloud computing environment, these components can be remotely arranged and can work together to realize the functions described in the present disclosure. Cloud computing can provide computing, software, data access and storage services, which do not require a terminal user to know the physical locations or configurations of the systems or hardware that provide these services. Cloud computing may provide services over a wide area network (such as the Internet) using an appropriate protocol. For example, a cloud computing provider provides applications through the wide area network, and they can be accessed through a browser or any other computing component. Cloud computing components and corresponding data may be stored on a remote server. Computing resources in the cloud computing environment may be merged at a remote data center location, or these computing resources can be dispersed. Cloud computing infrastructure may provide services through a shared data center, even if they appear to be a single point of access for users. Therefore, the cloud computing architecture may be used to provide the various functions described in the text herein from a remote service provider. Alternatively, they may be provided from a conventional server, or they may be installed on the client device directly or in other ways. In addition, the present disclosure may also be implemented as a computer program product which may include a computer-readable storage medium on which computer-readable program instructions for executing various aspects of the present disclosure are loaded.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processing unit of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the drawings illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It is also to be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1-29. (canceled)

30. A method for data processing, comprising:
obtaining input data; and
generating, by using a neural network, a predicted label indicating a class of the input data, the neural network comprising a weighted layer, the weighted layer determining at least a weight applied to at least one candidate class to generate a predicted result, the input data possibly belonging to the at least one candidate class.

31. The method according to claim 30, wherein the weighted layer further determines at least one mode parameter associated with a predetermined mode to generate the predicted result to cause the predicted result to obey the predetermined mode.

32. The method according to claim 31, wherein the predetermined mode comprises one of the following:
a Gaussian distribution,
a normal distribution,
a uniform distribution,
an exponential distribution,
a Poisson distribution,
a Bernoulli distribution, and
a Laplace distribution.

33. The method according to claim 31, wherein generating the predicted label comprises:
obtaining an output of at least one layer before the weighted layer in the neural network as an input of the weighted layer, the input indicating a possibility that the input data belongs to the at least one candidate class;
determining, based on at least one parameter of the weighted layer and the input of the weighted layer, at least one mode parameter associated with the predetermined mode and the weight applied to the at least one candidate class; and
generating the predicted label based on the at least one mode parameter, the weight, and a random value obeying a predetermined distribution.

34. The method according to claim 33, wherein the predetermined mode is a Gaussian distribution, and the at least one mode parameter comprises a mean value and a variance of the Gaussian distribution.

35. The method according to claim 30, wherein the neural network comprises one of the following:
a Deep Neural Network (DNN),
a Convolutional Neural Network (CNN),
a Long Short Term Memory (LSTM) Network,
a Gated Recurrent Unit (GRU) network, and
a Recurrent Neural Network (RNN).

36. The method according to claim 30, wherein the input data comprises at least one of the following:
an image,
a video,
an audio,
a text, and
a multimedia file.

37. A method for training a neural network, comprising:
obtaining training data having a label indicating a class of the training data;
generating, by using a neural network, a predicted label of the training data, the neural network comprising a weighted layer, the weighted layer generating a predicted result at least based on a weight applied to at least candidate class, the training data possibly belonging to the at least one candidate class; and
training the neural network to minimize a difference between the label and the predicted label.

38. The method according to claim 37, wherein the weighted layer further determines at least one mode parameter associated with a predetermined mode to generate the predicted result to cause the predicted result to obey the predetermined mode.

39. The method according to claim 38, wherein generating the predicted label comprises:
obtaining an output of at least one layer before the weighted layer in the neural network as an input of the weighted layer, the input indicating a possibility that the training data belongs to the at least one candidate class;
determining, based on at least one parameter of the weighted layer and the input of the weighted layer, at least one mode parameter associated with the predetermined mode and the weight applied to the at least one candidate class; and
generating the predicted label based on the at least one mode parameter, the weight, and a random value obeying a predetermined distribution.

40. The method according to claim 39, wherein the predetermined mode is a Gaussian distribution, and the at least one mode parameter comprises a mean value and a variance of the Gaussian distribution.

41. The method according to claim 37, wherein training the neural network comprises:
determining a loss of the neural network based on the label, the predicted label, and the weight applied to the at least one candidate class; and
updating network parameters of the neural network based on the loss to minimize the loss of the updated neural network.

42. The method according to claim 41, wherein updating the network parameters of the neural network based on the loss comprises:
updating at least one parameter of the weighted layer based on the loss to minimize the loss of the updated neural network.

43. A method for training a neural network, comprising:
obtaining training data having a label indicating a class of the training data;
generating, by using a neural network, a predicted label of the training data; and
training the neural network to minimize a loss of the neural network, the loss being determined at least based on a weight applied to at least candidate class, the training data possibly belonging to the at least one candidate class.

44. The method according to claim 43, wherein the neural network comprises a weighted layer that generates a predicted result based at least on the weight applied to the at least one candidate class.

45. The method according to claim 44, wherein the weighted layer further determines at least one mode parameter associated with a predetermined mode to generate the predicted result to cause the predicted result to obey the predetermined mode.

46. The method according to claim 45, wherein generating the predicted label comprises:
obtaining an output of at least one layer before the weighted layer in the neural network as an input of the weighted layer, the input indicating a possibility that the training data belongs to the at least one candidate class;
determining, based on at least one parameter of the weighted layer and an input of the weighted layer, at least one mode parameter associated with the predetermined mode and a weight applied to the at least one candidate class; and
generating the predicted label based on the at least one mode parameter, the weight, and a random value obeying a predetermined distribution.

47. The method according to claim 46, wherein the predetermined mode is a Gaussian distribution, and the at least one mode parameter comprises a mean value and a variance of the Gaussian distribution.

48. The method according to claim 43, wherein training the neural network comprises:
determining the loss based on the label, the predicted label, and the weight applied to the at least one candidate class; and
updating network parameters of the neural network based on the loss to minimize the loss of the updated neural network.

49. The method according to claim 48, wherein updating network parameters of the neural network based on the loss comprises:
updating at least one parameter of the weighted layer based on the loss to minimize the loss of the updated neural network.
